(19) United States
(12) Patent Application Publication
(10) Pub. No.: US 2006/0036854 A1
(43) Pub. Date: Feb. 16, 2006

(54) Portable virtual private network device

(76) Inventor: Chien-Hsing Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/610,794

(22) Filed: Aug. 9, 2004

(51) Int. Cl. H04L 9/00

(52) U.S. Cl. 713/165

(57) ABSTRACT

A portable virtual private network (VPN) device for providing VPN service to a host computer includes a network I/O port for transferring and receiving packets, a connection port electrically connected to an I/O port of the host computer for communicating with the host computer, and a VPN module for encrypting and decrypting packets according to the VPN protocol. The connection port supplies power received from the I/O port of the host computer to the VPN device so that the VPN device is capable of operating normally.

### BACKGROUND OF INVENTION

1. Field of the Invention

The present invention relates to a virtual private network (VPN) device, and more specifically, to a VPN device providing convenient and mobile VPN service to users without an additional power supply.

2. Description of the Prior Art

A virtual private network is a network utilizing the encrypting technology of the Internet Protocol (IP) to establish a virtual tunnel through the Internet in order to form a structure similar to a private network. The encrypting technology used in the VPN protocol is IP Security (IPSec). IPSec integrates several security, such as encryption, authentication, key management and digital certification, so that it provides outstanding performance for data protection. Using the IPSec standard protocol in combination with DES, 3-DES encryption, and unsymmetrical key management, even on the open Internet, data can be securely transferred in a VPN tunnel. Please refer to FIG. 1 and FIG. 2. FIG. 1 illustrates a VPN device 50 and a host computer 10 according to the prior art, and FIG. 2 is a block diagram illustrating the connection of host computer 10 and VPN device 50 shown in FIG. 1. The VPN device 50 includes two RJ-45 jacks 52, 54, and the ends of two network cables 14, 56 are inserted into the jacks 52, 54 respectively. The VPN device 50 is connected to a network card 12 in the host computer 10 through the network cable 14, and to the Internet 80 through the network line 56. The network card 12 is used to process operations related to network communication for the host computer 10, such as generating packets; and the VPN device 50 is used to provide VPN service to the host computer 10. The VPN device 50 encrypts the packets from the network card 12 according to the VPN protocol, then transfers the encrypted packets to the Internet 80. Furthermore, the VPN device 50 also decrypts and authenticates the packets from the Internet 80, then transfers the decrypted packets to the network card 12 so that the network card 12 can read the packets from the Internet 80, and the host computer 10 can receive data from the Internet 80. For example, when a host computer 90 establishes a virtual tunnel with the host computer 10 through another VPN device 92, if the VPN device 92 is going to transfer packets to the VPN device 50, the VPN device 92 will first encrypt the packets and transfer them to the VPN device 50 according to the VPN protocol, and then the VPN device 50 can decrypt the received packets according to the VPN protocol and corresponding key.

The VPN device 50 further includes a power inlet 58 connected to a power source 70 through an adapter 60. All the power necessary for operating the VPN device 50 is supplied by the power source 70, which means when the electrical connection between the VPN device 50 and the power source 70 is cut off, the VPN device 50 cannot operate anymore.

### SUMMARY OF INVENTION

It is therefore a primary objective of the present invention to provide a portable VPN device used to provide VPN service without any external power supply. Briefly summarized, a portable VPN device according to the present invention includes a control circuit used to control the operation of the VPN device, a network input/output (I/O) port connected to a network system for transferring packets to the network system and receiving packets from the network system, a connecting port electrically connected to a signal I/O port of the host computer, and a VPN module for encrypting and decrypting the packets according to the VPN protocol. The connecting port includes a signal terminal and a power input terminal. The signal terminal is used to transceive data with the host computer, and the power input terminal is electrically connected to a power output terminal of the signal I/O port for providing power to the VPN device in order to operate the VPN device.

Thus, the VPN device according to the present invention transfers signals and receives power supply through the connecting port. The connecting port can be a USB port, a parallel port, etc. Users just inserts the VPN device into a corresponding connecting port, the device will work.

### BRIEF DESCRIPTION OF DRAWINGS

FIG. 1 illustrates a conventional VPN device connected to a host computer.

FIG. 2 is a block diagram for the conventional VPN device connected to the Internet and the host computer.

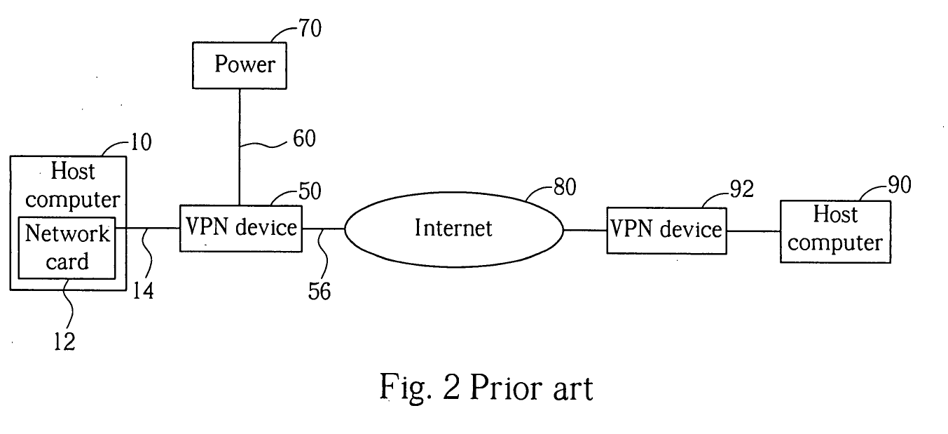

FIG. 3 illustrates a VPN device according to the first embodiment of the present invention.

FIG. 4 illustrates another side of the VPN device shown in FIG. 3.

FIG. 5 illustrates the conventional VPN device connected to the host computer.

FIG. 6 is a block diagram for the VPN device connected to the Internet and the host computer.

FIG. 7 illustrates a VPN device according to the second embodiment of the present invention.

### DETAILED DESCRIPTION

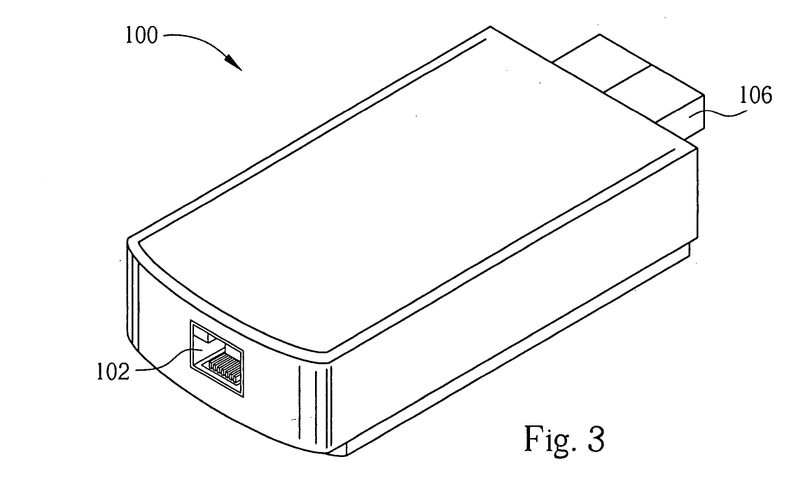

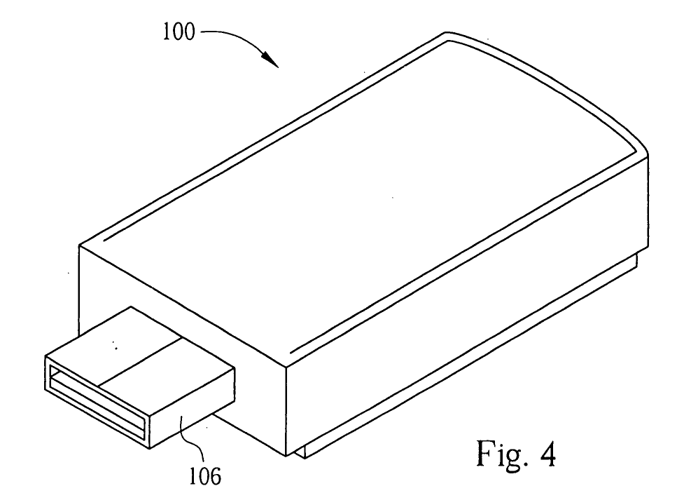

Please refer to FIG. 3 and FIG. 4. FIG. 3 illustrates a VPN device 100 according to the first embodiment of the present invention, and FIG. 4 illustrates another side of the VPN device 100 shown in FIG. 3. In this embodiment, the length of the VPN device is approximately 5-10 cm, and the width is approximately 3 cm, meaning the VPN device 100 is easy to carry. The VPN device 100 includes a network I/O port 102 and a connecting port 106, in which the network I/O port 102 is used to connect to the Internet by a network cable, and the connecting port 106 is a USB port for connecting to a host computer.

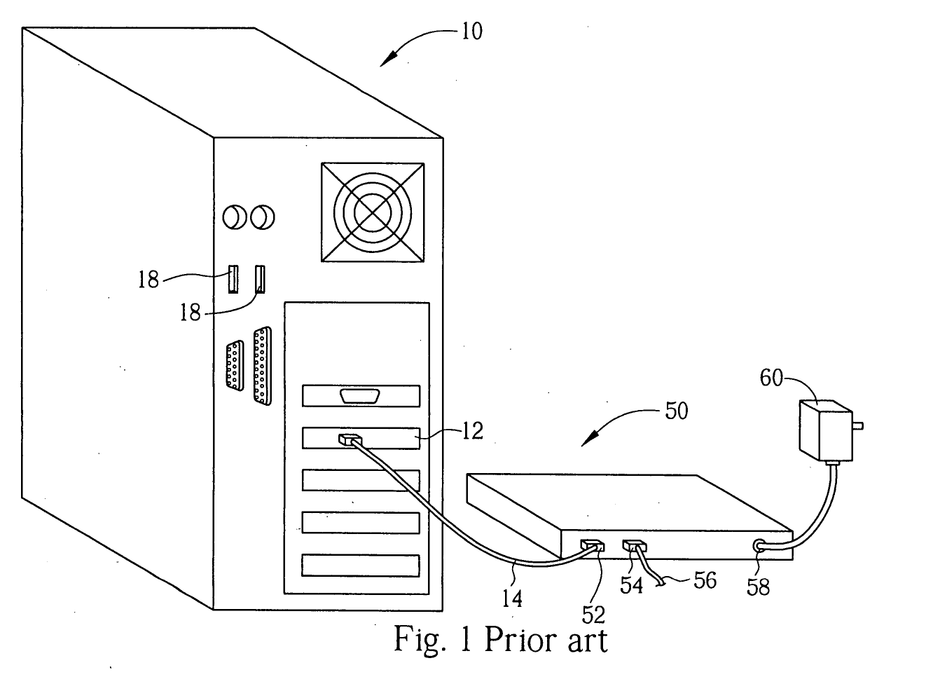

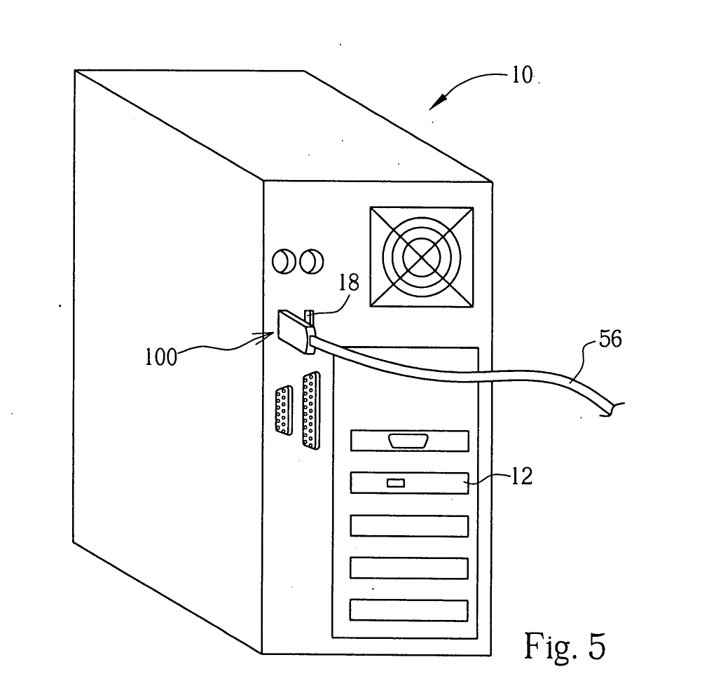

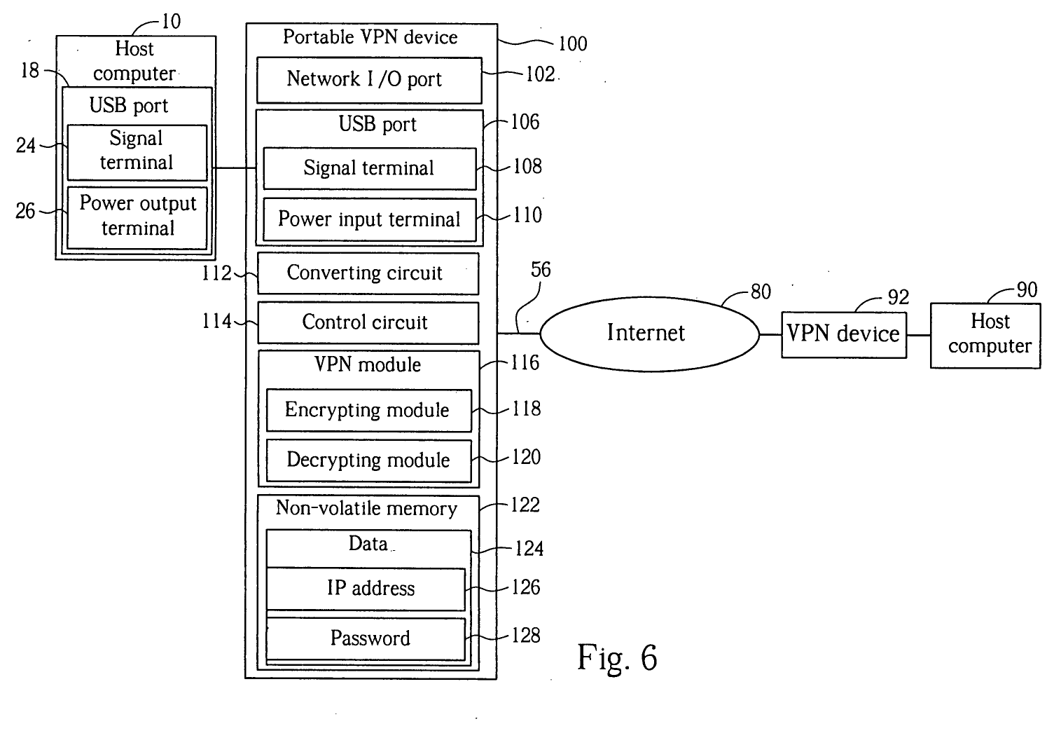

Please refer to FIG. 5 and FIG. 6. FIG. 5 illustrates the VPN device 100 connected to the host computer 10, and FIG. 6 illustrates the VPN device 100 connected to the Internet 80 and the host computer 10. According to FIG. 5, the connecting port 106 can be inserted into a USB connecting port 18 (the USB connecting port 18 is hereinafter referred to as a signal I/O port 18 for convenience of explanation) of the host computer 10, and the network I/O port 102 is connected to the network cable 56. In contrast to the prior art, the VPN device 100 replaces both the network card 12 and the conventional VPN device 50 shown in FIG. 1, and directly provides VPN service to the host computer 10.

According to USB standard, the signal I/O port 18 includes at least one signal terminal 24 for transferring data and at least one power output terminal for supplying power. Correspondingly, the connecting port 106 of the VPN device 100 includes a signal terminal 108 connected to the signal terminal 24 for transferring data, and a power input terminal electrically connected to the power output terminal 26 for power input from the power output terminal 26 to the VPN device 100 in order to operate the VPN device 100. Thus, in contrast to the conventional VPN device 50 which needs an additional external power source 70, all the necessary power of the VPN device 100 is from the power output terminal 26 of the signal I/O port 18, so that the VPN device 100 can operate normally without any external power supply.

The VPN device 100 further includes a control circuit 114 for controlling the operation of the VPN device 100, a VPN module 116, and a non-volatile memory 122. The VPN module 116 can be implemented by means of either hardware or software. If the VPN module 116 is implemented by means of hardware, it is included in the control circuit 114. If the VPN module 116 is implemented by means of software, the program code of the VPN module 116 is stored in the non-volatile memory 122, and can be read and executed by the control circuit 114 when the VPN device 100 is activated. The VPN module 116 includes an encrypting module 118 and a decrypting module 120. The encrypting module 118 encrypts packets according to the VPN protocol and transfers the encrypted packets to the Internet 80 through the network I/O port 102. In this embodiment, the encrypting module 118 encrypts packets with the DES algorithm. The decrypting module 120 decrypts packets according to the VPN protocol and transfers the data after decrypting packets to the host computer 10 through the signal terminal 108 of the connecting port 106. The non-volatile memory 122 is used to store the data for setting the VPN device 100, such as an IP address 126, a password 128, etc. In this embodiment, the IP address 126 is the address of the VPN device 92 on the Internet 80, and the encrypting module 118 will utilize the IP address 126 to modify the packets output to the Internet 80, so that the packets output by the VPN device 100 can be transferred to the VPN device 92 to form a virtual tunnel between the VPN device 92 and the VPN device 100. Furthermore, the password 128 stored in the non-volatile memory 122 includes a public key and a private key for establishing the VPN and for encrypting and decrypting data. For example, the VPN module 116 can encrypt and decrypt packets using the public key and the private key included in the password 128.

The VPN device 100 further includes a converting circuit 112 electrically connected between the connecting port 106 and the control circuit 114 for converting signals between the connecting port 106 and the control circuit 114. The converting circuit 112 ensures that the signal transferred from the connecting port 106 to the control circuit 114 is compatible with the clock of the control circuit 114. Additionally, the signal transferred from the control circuit 114 to the connecting port 106 is compatible with the clock of the connecting port 106, so that the connecting port 106 and the control circuit 114 can mutually transfer data.

As mentioned above, the connecting port 106 is a USB port. However, the connecting port 106 according to the present invention is not limited to USB port. Any connecting port providing both power supply and data transfer is acceptable in the present invention. For example, the connecting port 106 can be an IEEE 1394 port, a parallel port, a PCMCIA port or an RJ-45 port, as all of the ports according to the standards mentioned above have a power pin for power supply. The RS232 port has a handshake pin normally maintained in high level, so that it can be utilized as the power input terminal 110 in the present invention. Of course, the standard of the signal I/O port 18 must conform to the standard of the connecting port 106 and can be an IEEE 1394 port, a parallel port, a PCMCIA port, an RS232 port or an RJ-45 port.

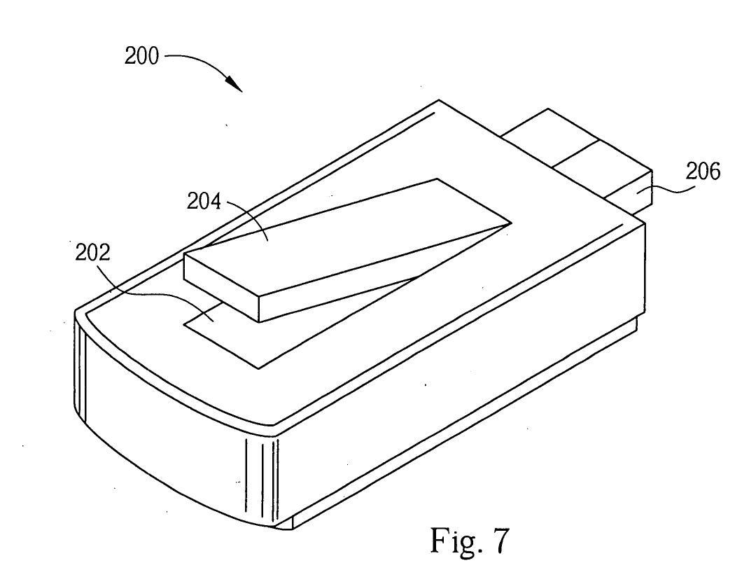

Moreover, the VPN device 100 supports the plug-and-play mode. After inserting the connecting port 106 of the VPN device 100 to the signal I/O port 18, the host computer 10 will detect and properly control the VPN device 100. In addition, the VPN device according to the present invention can not only communicate with the Internet 80 through wired transfer, but also through wireless transfer. Please refer to FIG. 7. FIG. 7 illustrates a VPN device 200 according to the second embodiment of the present invention. The function and the components of the VPN device 200 are the same as those of the VPN device 100, so the description is omitted. The network I/O port of the VPN device 200 includes an antenna 204 for transferring and receiving packets wirelessly. Therefore, the VPN device 200 can be connected to the Internet 80 without any network cables. In contrast to the prior art, the VPN device according to the present invention is a compact and portable device that can operate normally by the power from the power output terminal of the signal I/O port on the host computer, without any additional power supply. It is therefore superior to the prior art in both convenience and mobility. In addition, the VPN device according to the present invention supports plug-and-play mode, and the corresponding VPN setting values are stored in the non-volatile memory so that the network administrator can simply insert or remove the VPN device from the corresponding port when installing or uninstalling the VPN.

Those skilled in the art will readily observe that numerous modifications and alterations of the device may be made while retaining the teachings of the invention. Accordingly, the above disclosure should be construed as limited only by the metes and boundaries of the appended claims.

What is claimed is:

1. A portable virtual private network (VPN) device used to provide VPN service to a host computer comprising:
a control circuit used to control the operation of the VPN device;
a network input/output (I/O) port connected to a network system, used to transfer packets to the network system and receive packets from the network system;
a connecting port electrically connected to a signal I/O port of the host computer, the connecting port comprising:
a signal terminal used to transfer data to the host computer and receive data from the host computer; and
a power input terminal electrically connected to a power output terminal of the signal I/O port, used to supply power from the power output terminal to the VPN device; and
a VPN module comprising:
an encrypting module used to encrypt the packets according to a VPN protocol and transfer the encrypted packets to the network system through the network I/O port; and
a decrypting module used to decrypt the packets according to the VPN protocol and transfer data after decrypting the packets to the host computer through the signal terminal of the connecting port.

2. The VPN device of claim 1 further comprising a non-volatile memory used to store data for setting the VPN device, wherein the VPN module will encrypt and decrypt the packets according to the setting values stored in the non-volatile memory.

3. The VPN device of claim 2 wherein the setting values comprises an internet protocol (IP) address and the encrypting module will use the IP address to modify the packets transferred to the network system.

4. The VPN device of claim 1 further comprising a converting circuit electrically connected between the connecting port and the control circuit so that the connecting port and the control circuit can mutually transfer data.

5. The VPN device of claim 1 further comprising an antenna used to transfer and receive the packets wirelessly.

6. The VPN device of claim 1 wherein the network I/O port is a network line connector used to connect to a network line so that the VPN device can transfer the packets from the network system and receive the packets from the network system through the network connector and the network line.

7. The VPN device of claim 1 wherein the connecting port is a USB port and the signal I/O port of the host computer is also a USB port.

8. The VPN device of claim 1 wherein the connecting port is an IEEE 1394 port and the signal I/O port of the host computer is also an IEEE 1394 port.

9. The VPN device of claim 1 wherein the connecting port is a parallel port and the signal I/O port of the host computer is also a parallel port.

10. The VPN device of claim 1 wherein the connecting port is a PCMCIA port and the signal I/O port of the host computer is also a PCMCIA port.

11. The VPN device of claim 1 wherein the connecting port is an RS232 port and the signal I/O port of the host computer is also an RS232 port.

12. The VPN device of claim 1 wherein the connecting port is an RJ-45 port and the signal I/O port of the host computer is also an RJ-45 port.

13. The VPN device of claim 8 wherein the network system is the Internet.
